(19) United States
(12) Patent Application Publication
(10) Pub. No.: US 2020/0313973 A1
(43) Pub. Date: Oct. 1, 2020

(54) DATA PROCESSING APPARATUS, DATA PROCESSING METHOD, AND NON-TRANSITORY COMPUTER READABLE MEDIUM STORING DATA PROCESSING PROGRAM

(71) Applicant: FUJI XEROX CO., LTD., Tokyo (JP)

(72) Inventor: Tomoka NAKAGAWA, Kanagawa (JP)

(73) Assignee: FUJI XEROX CO., LTD., Tokyo (JP)

(21) Appl. No.: 16/521,575

(22) Filed: Jul. 24, 2019

(30) Foreign Application Priority Data
Mar. 25, 2019 (JP) 2019-055810

(51) Int. Cl. H04L 12/24; H04L 29/06

(52) U.S. Cl. CPC H04L 41/12; H04L 67/12; H04L 69/24

(57) ABSTRACT

A data processing apparatus includes a setting section that sets information related to a purpose of collecting data from an apparatus group including plural apparatuses, a recognition section that recognizes a non-registered apparatus which performs bidirectional communication and is not yet registered as a data collection target, and an apparatus management section that registers the non-registered apparatus in a case where data conforming with the purpose set by the setting section is collected from the non-registered apparatus recognized by the recognition section.

### CROSS-REFERENCE TO RELATED APPLICATIONS

This application is based on and claims priority under 35 USC 119 from Japanese Patent Application No. 2019-055810 filed Mar. 25, 2019.

### BACKGROUND

### (i) Technical Field

The present invention relates to a data processing apparatus, a data processing method, and a non-transitory computer readable medium storing a data processing program.

### (ii) Related Art

JP2011-097461A discloses a data processing apparatus that sets a management policy in advance for an apparatus not registered yet (hereinafter, referred to as the “non-registered apparatus”) and registers the non-registered apparatus by classifying the non-registered apparatus into any of a management target or a non-management target in accordance with the management policy in a case where the non-registered apparatus is detected. In addition, four selection options of “permit registration of management target”, “permit registration of non-management target”, “request determination of registration”, and “do nothing” are exemplified as the management policy.

### SUMMARY

In an Internet of Things (IoT) system in which various devices are connected to a network, it may be required to collect only data for which a user consents to the use of data due to a request for protecting private information. Therefore, it is considered that a manager of the data processing apparatus performs an operation of individually and specifically determining whether or not to register the non-registered apparatus as a data collection target and performing setting through the apparatus.

However, in a case where whether or not to register as the apparatus of the data collection target is set for each apparatus, the manager has to determine and set whether or not to permit registration each time the connection of the non-registered apparatus to the network is recognized. Thus, the number of works of the manager is increased. Particularly, in the IoT system, the number of apparatuses or the number of types of apparatuses as information sources tends to be increased, and the problem of the work load of the manager may become more noticeable.

Aspects of non-limiting embodiments of the present disclosure relate to a data processing apparatus, a data processing method, and a non-transitory computer readable medium storing a data processing program that reduce the number of processes for a non-registered apparatus compared to a case where a work of setting whether or not to register the non-registered apparatus as a data collection target is required for each apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a data processing apparatus including a setting section that sets information related to a purpose of collecting data from an apparatus group consisting of a plurality of apparatuses, a recognition section that recognizes a non-registered apparatus which performs bidirectional communication and is not yet registered as a data collection target, and an apparatus management section that registers the non-registered apparatus in a case where data conforming with the purpose set by the setting section is collected from the non-registered apparatus recognized by the recognition section.

### BRIEF DESCRIPTION OF THE DRAWINGS

Exemplary embodiment(s) of the present invention will be described in detail based on the following figures, wherein:

FIG. 1 is an overall configuration diagram of a data collection system in one exemplary embodiment of the present invention;

FIG. 2 is a network configuration diagram in an installation area illustrated in FIG. 1;

FIG. 3 is an electrical block diagram of an image processing apparatus illustrated in FIG. 1 and FIG. 2;

FIG. 4 is a function block diagram of a main controller illustrated in FIG. 3;

FIGS. 5A to 5C are diagrams illustrating one example of a data structure of apparatus management information in FIG. 4;

FIG. 6 is a flowchart related to a first operation of the image processing apparatus;

FIG. 7 is a diagram illustrating one example of a setting screen related to a data collection service;

FIG. 8 is a flowchart related to a second operation of the image processing apparatus;

FIG. 9 is a flowchart related to a third operation of the image processing apparatus; and

FIG. 10 is a diagram illustrating one example of a data structure of an apparatus candidate list.

### DETAILED DESCRIPTION

A data processing apparatus according to an exemplary embodiment of the present invention will be described in a relationship with a data processing method and a data processing program with reference to the appended drawings. The present invention is not limited to the following exemplary embodiment and may be freely changed without departing from the gist of the invention. Alternatively, any technically non-contradictory combination of each configuration may be made.

### Configuration of Data Collection System 10

### Overall Configuration

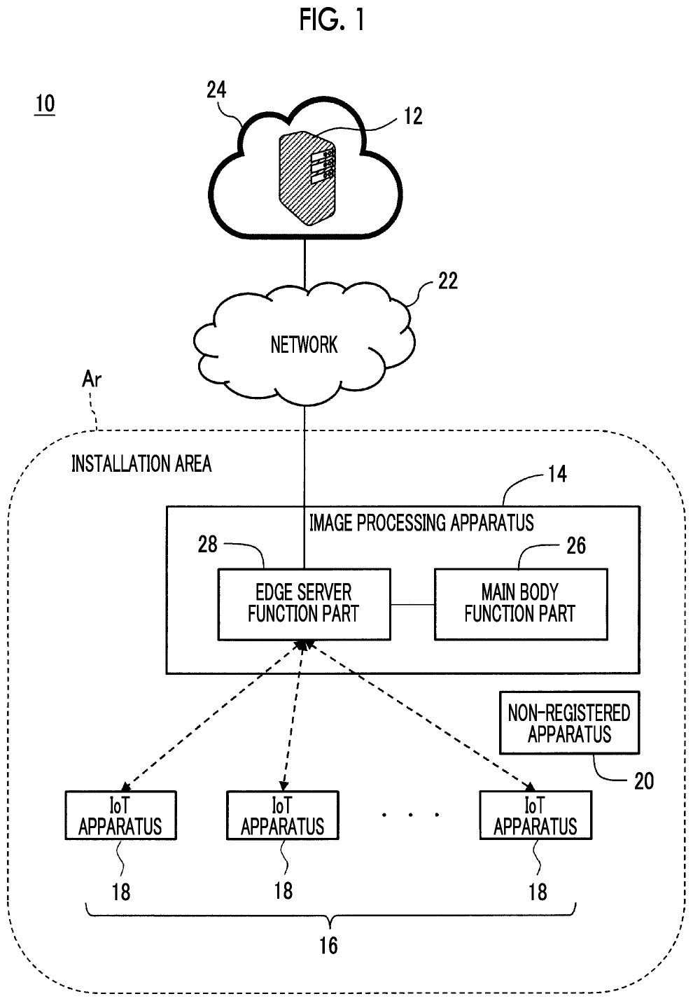

FIG. 1 is an overall configuration diagram of a data collection system 10 in one exemplary embodiment of the present invention. The data collection system 10 is a system configured to be capable of providing an “image processing service” for performing image processing for a user in an installation area Ar and a “data collection service” for collecting and analyzing data sequentially generated in the installation area Ar in combination with each other.

Specifically, the data collection system 10 is configured to include a central server 12, an image processing apparatus 14 as an edge server (or a data collection apparatus) , and an apparatus group 16 consisting of plural Internet of Things (IoT) apparatuses 18. The image processing apparatus 14 and the apparatus group 16 are disposed in the installation area Ar such as an office. The image processing apparatus 14 is configured to be capable of bidirectional communication with the central server 12 through a network 22. While only one image processing apparatus 14 is illustrated in FIG. 1, plural image processing apparatuses 14 may be arranged in one installation area Ar. In addition, while only one installation area Ar is illustrated in FIG. 1, other installation areas different from the installation area Ar may be present.

The central server 12 consists of one or plural server computers arranged on a cloud 24. The central server 12 performs various processes for collecting data from the image processing apparatus 14 as the edge server and using the data. The central server 12 may be a cloud type server (so-called cloud server) or an on-premises type server.

The image processing apparatus 14 is a digital multifunction peripheral (so-called MFP) that executes at least one of a print function, a copy function, a scan function, a facsimile function, or a data transmission function. The image processing apparatus 14 includes a main body function part 26 basically having a function related to the “image processing service” and an edge server function part 28 basically having a function related to the “data collection service”.

The edge server is not limited to an apparatus configuration obtained by adding the edge server function part 28 to the image processing apparatus 14. For example, the edge server function part 28 may be mounted in various apparatuses including a main body function part different from the image processing apparatus 14. Alternatively, the edge server may be configured as a dedicated apparatus having only the edge server function part 28.

The IoT apparatus 18 is an apparatus having a generation function of generating data using signals from various sensors mounted in the IoT apparatus 18 or generating data by executing various functions of the IoT apparatus 18, and a communication function of transmitting the generated data to the outside of the IoT apparatus 18 by wired communication or wireless communication. The IoT apparatus 18 may be a stationary type apparatus (for example, a computer apparatus, a communication apparatus, an office apparatus, an illumination apparatus, an air conditioning apparatus, or a measuring apparatus) in the installation area Ar or may be a portable type apparatus (for example, a laptop, a tablet, a smartphone, or a wearable device) that may be carried into the installation area Ar. The image processing apparatus 14 including the main body function part 26 may be regarded as the IoT apparatus 18.

The image processing apparatus 14 collects data from only the IoT apparatus 18 that is already registered as a data collection target. Hereinafter, the IoT apparatus 18 that is not registered as the data collection target may be referred to as a “non-registered apparatus 20” for distinction between registration and non-registration.

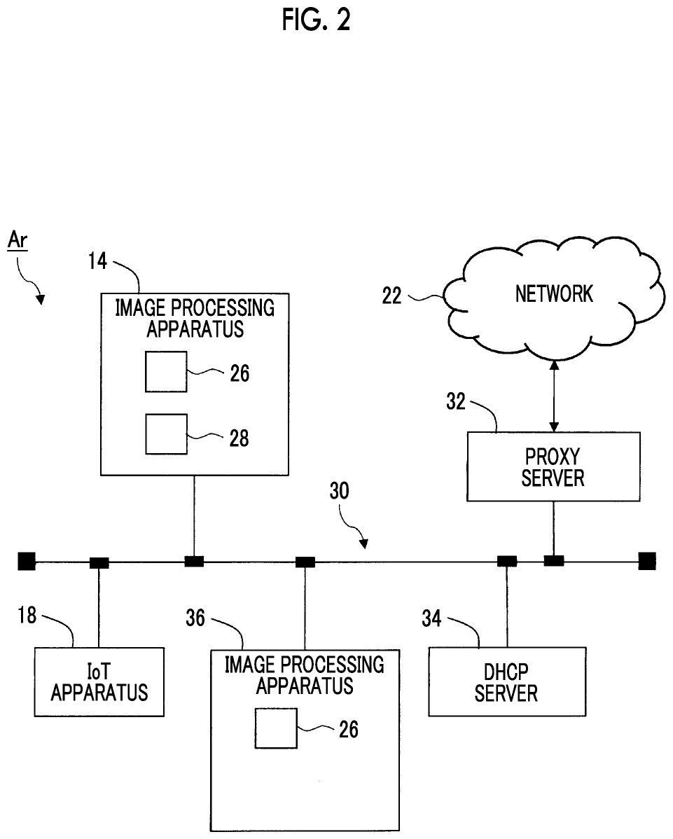

FIG. 2 is a network configuration diagram in the installation area Ar illustrated in FIG. 1. A small area network (hereinafter, referred to as a LAN 30) is set up in the installation area Ar. The image processing apparatus 14, the IoT apparatus 18, a proxy server 32, a dynamic host configuration protocol (DHCP) server 34, and an image processing apparatus 36 are connected to the LAN 30.

The proxy server 32 is a server that communicates with external apparatuses including the central server 12 instead of various apparatuses connected to the LAN 30. The DHCP server 34 is a server that sets and manages network information for apparatuses in the LAN 30. The apparatus configuration of the image processing apparatus 36 does not include the edge server function part 28 and thus, is different from the image processing apparatus 14.

### Electrical Block Diagram of Image Processing Apparatus 14

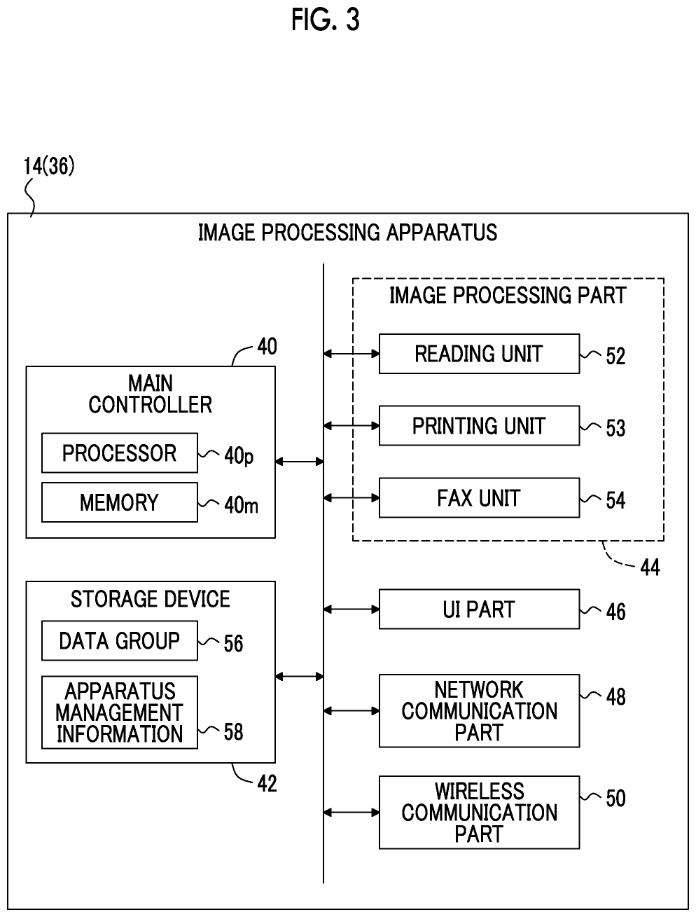

FIG. 3 is an electrical block diagram of the image processing apparatuses 14 and 36 illustrated in FIG. 1 and FIG. 2. The image processing apparatuses 14 and 36 are configured to include a main controller 40, a storage device 42 (corresponds to a “storage section”), an image processing part 44, a user interface part (hereinafter, referred to as a UI part 46), a network communication part 48, and a wireless communication part 50.

The image processing part 44 is configured to include a reading unit 52 generating image data by reading paper, a printing unit 53 outputting a printed matter based on the image data, and a FAX unit 54 transmitting and receiving facsimiles. For example, the UI part 46 consists of a touch panel display and a hardware button and receives an input operation performed by the user.

The network communication part 48 is a communication module for performing network communication with external apparatuses including the central server 12. The wireless communication part 50 is a communication module for performing wireless communication with external apparatuses including the IoT apparatus 18. The “wireless communication” includes wireless communication in a narrow sense using electric waves and also spatial light communication (specifically, infrared communication or visible light communication) using spatial light.

The main controller 40 is a device that is configured to include a processor 40p and a memory 40m and controls each part constituting the image processing apparatus 14. The processor 40p is a processing and operating device including a central processing unit (CPU) and a micro-processing unit (MPU). The memory 40m is a non-transitory computer readable storage medium.

For example, the storage device 42 consists of a hard disk drive (HDD) or a solid state drive (SSD) and stores various data handled by the image processing apparatus 14. The storage device 42 stores a data group 56 and apparatus management information 58, described below, with respect to the image processing apparatus 14 including the edge server function part (FIG. 1).

### Function Block Diagram of Main Controller 40

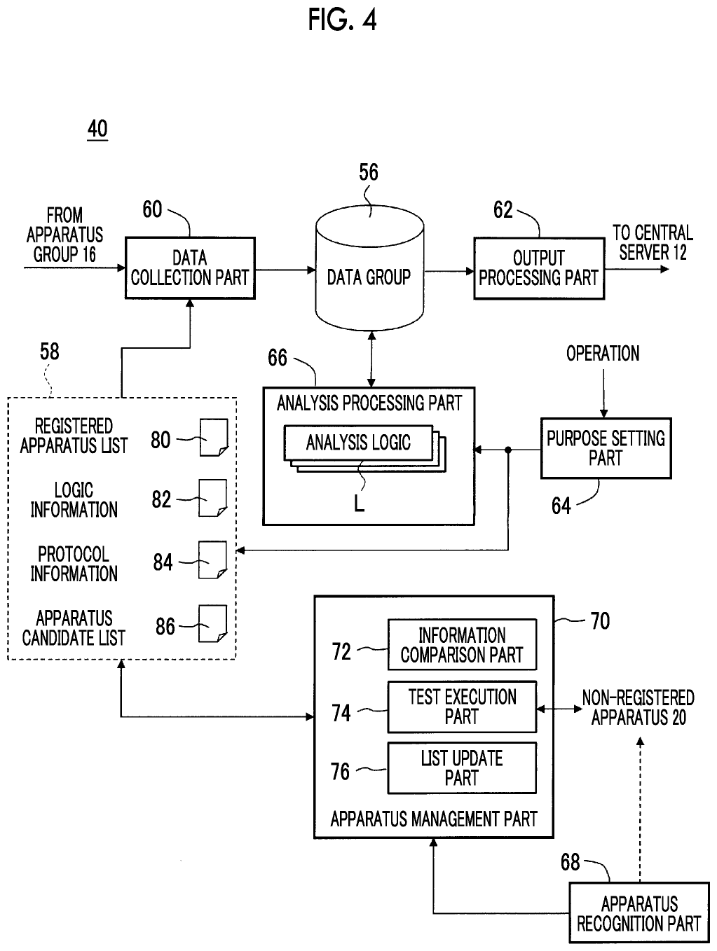

FIG. 4 is a function block diagram of the main controller 40 illustrated in FIG. 3. The processor 40p of the main controller 40 functions as a data collection part 60, an output processing part 62, a purpose setting part 64 (corresponds to a “setting section”), an analysis processing part 66 (corresponds to an “analysis section”), an apparatus recognition part 68 (corresponds to a “recognition section”), and an apparatus management part 70 (corresponds to an “apparatus management section”) by reading and executing a program related to the data collection service from the memory 40m.

The data collection part 60 collects data generated by plural IoT apparatuses 18 listed on a registered apparatus list 80, that is, the apparatus group 16. The data collection part 60 temporarily stores the collected data periodically or non-periodically in the storage device 42 (FIG. 3) in association with apparatus information described below.

The output processing part 62 performs a desired output process (for example, encryption of data and creation of transmission data) on at least a part of data in the data group 56 and outputs the obtained transmission data to the central server 12.

The purpose setting part 64 sets a purpose (hereinafter, referred to as a “collection purpose”) of collecting data from the apparatus group 16 or information related to the purpose in response to a setting operation performed by a manager. The analysis processing part 66 outputs analyzed data by performing an analysis process on data in accordance with one or plural analysis logics L. The analysis process may be a process equivalent to an analysis process performed by the central server 12 or a process of manipulating data for facilitating the analysis process of the central server 12. The apparatus recognition part 68 recognizes one or plural non-registered apparatuses 20 that may perform bidirectional communication with the image processing apparatus 14.

The apparatus management part 70 performs a registration process related to the IoT apparatus 18 as the data collection target. Specifically, the apparatus management part 70 includes an information comparison part 72, a test execution part 74, and a list update part 76.

The apparatus management information 58 corresponds to various information that is provided to the data collection part 60 or the apparatus management part 70 at an appropriate timing. In the example in FIG. 4, the apparatus management information 58 includes a registered apparatus list 80, logic information 82, protocol information 84, and an apparatus candidate list 86.

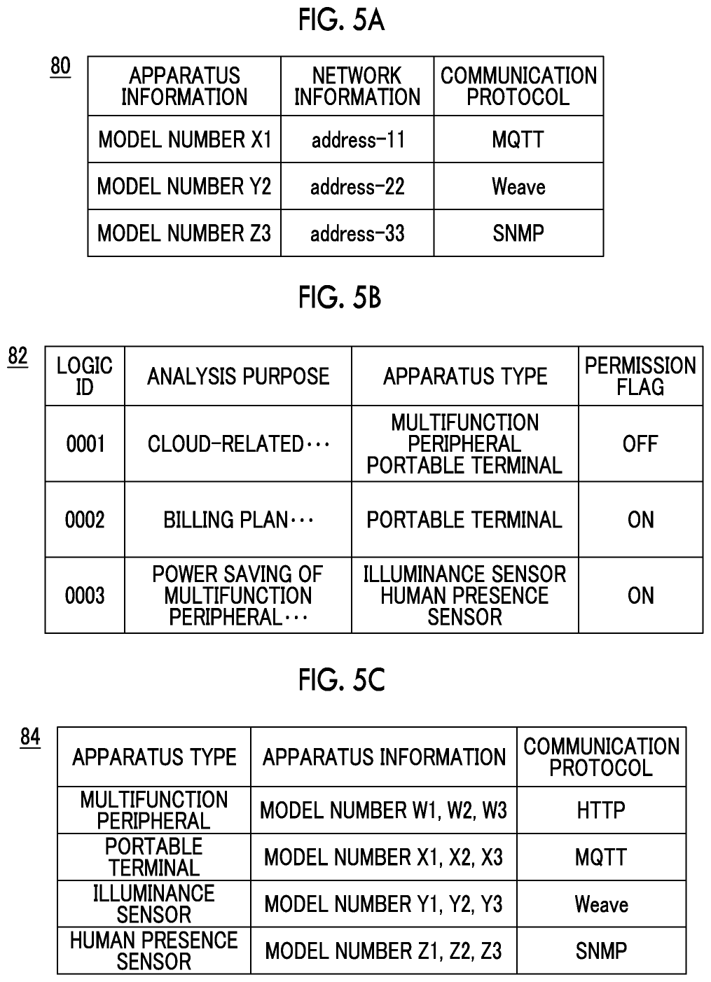

FIGS. 5A to 5C are diagrams illustrating one example of a data structure of the apparatus management information 58 in FIG. 4. In the example in FIGS. 5A to 5C, the apparatus management information 58 consists of four types of table data. The apparatus management information 58 may have different data structures.

FIG. 5A illustrates one example of a data structure of the registered apparatus list 80. The registered apparatus list 80 consists of table data indicating a correspondence relationship among the apparatus information, the network information, and a communication protocol. The “apparatus information” is information enabling identification or classification of the IoT apparatus 18 and is exemplified by, for example, a product model number, a MAC address, and DHCP option 60 (that is, a vendor class ID). In addition, specific examples of the “network information” are exemplified by an IP address, a subnet mask, a host name, and the like. In addition, the “communication protocol” is a communication protocol used at the time of collecting data and is exemplified by, for example, MQTT, AMQP, CoAP, HTTP, SNMP, Weave, and Websocket.

FIG. 5B illustrates one example of a data structure of the logic information 82. The logic information 82 consists of table data indicating a correspondence relationship among a “logic ID” indicating an identification number of the analysis logic L, an “analysis purpose” indicating the purpose of analyzing data, an “apparatus type” indicating the type of IoT apparatus 18, and a “permission flag” indicating a permission state related to collection of data.

FIG. 5C illustrates one example of a data structure of the protocol information 84. The protocol information 84 consists of table data indicating a correspondence relationship among the “apparatus type”, the “apparatus information”, and the “communication protocol”.

### Operation of Image Processing Apparatus 14

The data collection system 10 in the exemplary embodiment is configured as described above. Next, the operation of the image processing apparatus 14 will be separately described in [1] setting of the collection purpose and [2] automatic registration of the non-registered apparatus 20.

### Setting of Collection Purpose

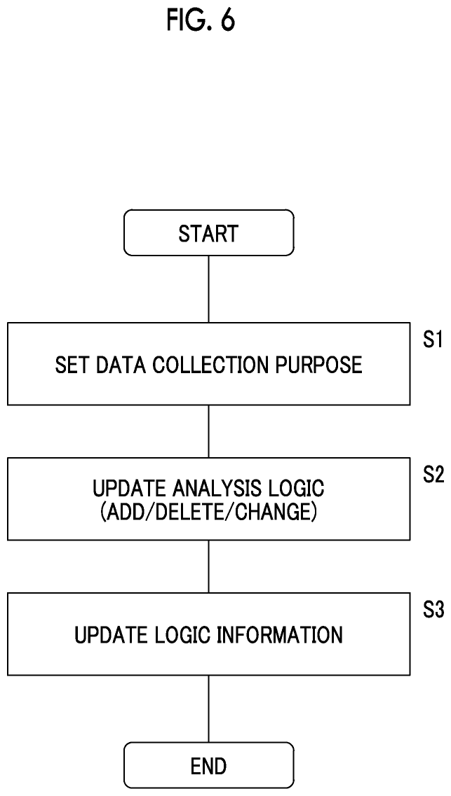

First, the operation of the image processing apparatus 14 related to the “setting of the collection purpose” will be described with reference to the flowchart in FIG. 6.

In step S1, the purpose setting part 64 sets the data collection purpose in response to the setting operation performed by the manager. For example, the collection purpose is exemplified by [1] recognizing a usage situation of a portable terminal and a multifunction peripheral and suggesting a cloud-related solution matching a usage environment of a customer, [2] recognizing the usage situation of the portable terminal and suggesting an optimal billing plan matching the usage environment of the customer, and [3] recognizing a usage situation of illumination and suggesting a power saving control method of the multifunction peripheral matching the usage environment of the customer.

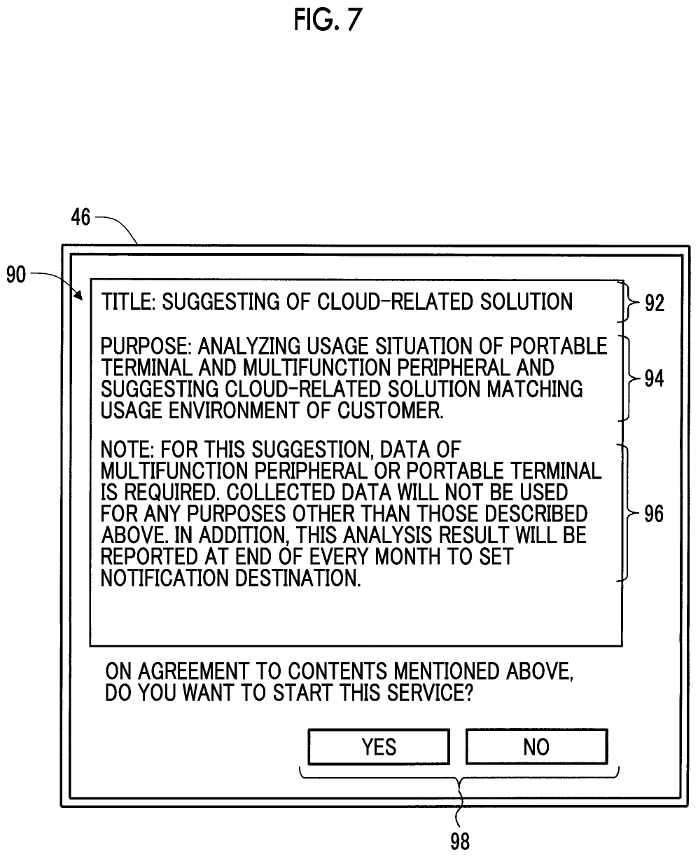

FIG. 7 is a diagram illustrating one example of a setting screen 90 related to the data collection service. The setting screen 90 may be displayed on the UI part 46 of the image processing apparatus 14 or may be displayed on a display part of a manager terminal not illustrated. A title field 92 displaying the title of the analysis logic L, a purpose field displaying the collection purpose, a note field 96 displaying a message, and a button group 98 consisting of “yes” and “no” are arranged from the upper side to the lower side on the setting screen 90.

The manager checks the content of the setting screen 90 and performs a setting operation of tapping “yes” in the button group 98 in the case of permitting the start of the service “suggesting the cloud-related solution”. Then, the main controller 40 obtains operation data indicating the logic ID (for example, 0001) and the permission flag (for example, ON).

The purpose setting part 64 may set related information related to the purpose instead of the collection purpose. The related information corresponds to various information enabling specifying of the collection target and, for example, may include at least one of [1] abbreviating the purpose (for example, “cloud-related” and “power saving of the multifunction peripheral”), [2] identification information (for example, the logic ID) of the analysis logic L, [3] a type of data item (for example, positional information, biometric information, and system operation information) , or [4] the type of IoT apparatus 18 (for example, a multifunction peripheral, a portable terminal, and a human presence sensor).

For example, the purpose setting part 64 may set the identification information of the analysis logic L receiving an input of data including plural data items and outputting an analysis result corresponding to the collection purpose as the related information of the purpose. Accordingly, plural data items may be collectively set through one analysis logic L, and the handleability of data is improved compared to a case of individually setting plural data items.

In the above example, the collection purpose and the analysis logic L are associated in a “one-to-one” relationship. The correspondence relationship between the collection purpose and the analysis logic L is not for limitation purposes and may be “one-to-many”, “many-to-one”, or “many-to-many”. In addition, in a case where information having a high abstraction degree (for example, a sentence input as a text) is set as the collection purpose, the purpose setting part 64 may select the analysis logic L conforming with the purpose by analyzing the information.

In step S2, the purpose setting part 64 provides an instruction to update (that is, add, change, or delete) the analysis logic L to conform with the setting content in step S1. For example, in a case where the analysis processing part 66 adds or changes the analysis logic L that may be executed, an add-on program of the update target is installed. In the case of deleting the analysis logic L, the add-on program of the update target is uninstalled.

The analysis processing part 66 (analysis section) that performs the analysis process on data in accordance with one or plural analysis logics L set by the purpose setting part 64 may be disposed in the image processing apparatus 14. Accordingly, collection and analysis of data may be executed in a closed environment in one apparatus, and the use of data for other than the set purpose is reduced compared to a case of requesting another apparatus to analyze data.

In step S3, the purpose setting part 64 updates the logic information 82 to conform with the setting content in step S1. For example, the purpose setting part 64 sets the value of the “permission flag” to “ON” in the case of permitting the use of the analysis logic L and sets the value of the “permission flag” to “OFF” in the case of not permitting the use of the analysis logic L. The operation of the image processing apparatus 14 related to the “setting of the collection purpose” is ended.

### Automatic Registration of Non-Registered Apparatus 20

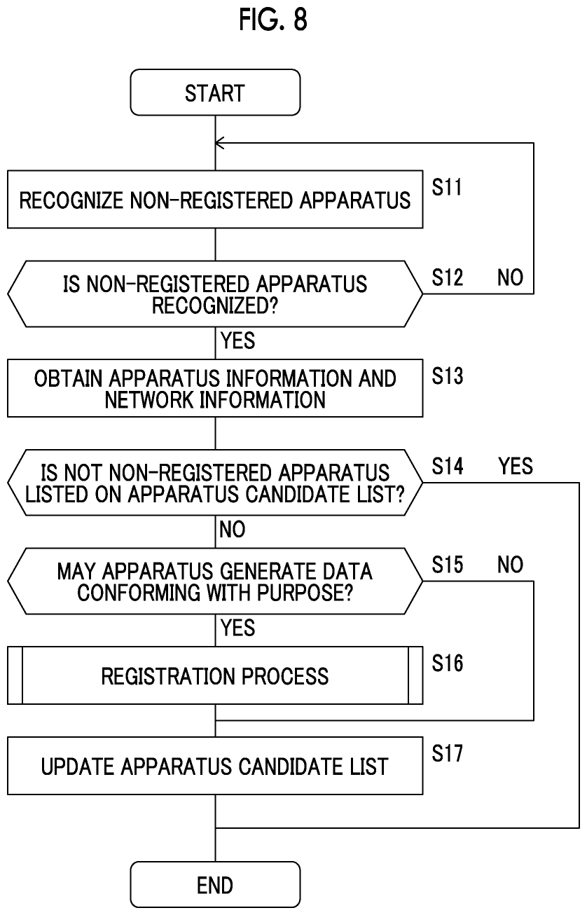

Next, the operation of the image processing apparatus 14 related to the “automatic registration of the non-registered apparatus 20” will be described with reference to the flowchart in FIG. 8.

In step S11, the apparatus recognition part 68 recognizes the non-registered apparatus 20 that may perform bidirectional communication with the image processing apparatus 14. Specifically, the apparatus recognition part 68 may recognize the IP address of the non-registered apparatus 20 or a universally unique identifier (UUID) that is the apparatus information of the non-registered apparatus 20 by notification from the DHCP server 34, detection of a simple network management protocol (SNMP) trap, and the like.

In step S12, the apparatus recognition part 68 checks the recognition result of step S11. In a case where the non-registered apparatus 20 is not recognized (NO in step S12), a return is made to step S11, and steps S11 and S12 are sequentially repeated until the non-registered apparatus 20 is newly recognized. In a case where the non-registered apparatus 20 is recognized (YES in step S12) , a transition is made to subsequent step S13.

In step S13, the apparatus management part 70 obtains the apparatus information and the network information of the non-registered apparatus 20 recognized in step S11. The information source may be the non-registered apparatus 20, the DHCP server 34, or other apparatuses or may be the image processing apparatus 14 (that is, the apparatus recognition part 68) in a case where the apparatus information and the network information are already obtained in step S11. For example, the image processing apparatus 14 may connect to the non-registered apparatus 20 using the SNMP protocol based on the IP address obtained by the apparatus recognition part 68 and obtain the apparatus information such as the apparatus name, apparatus type, apparatus model number, and type of usable communication protocol of the non-registered apparatus 20.

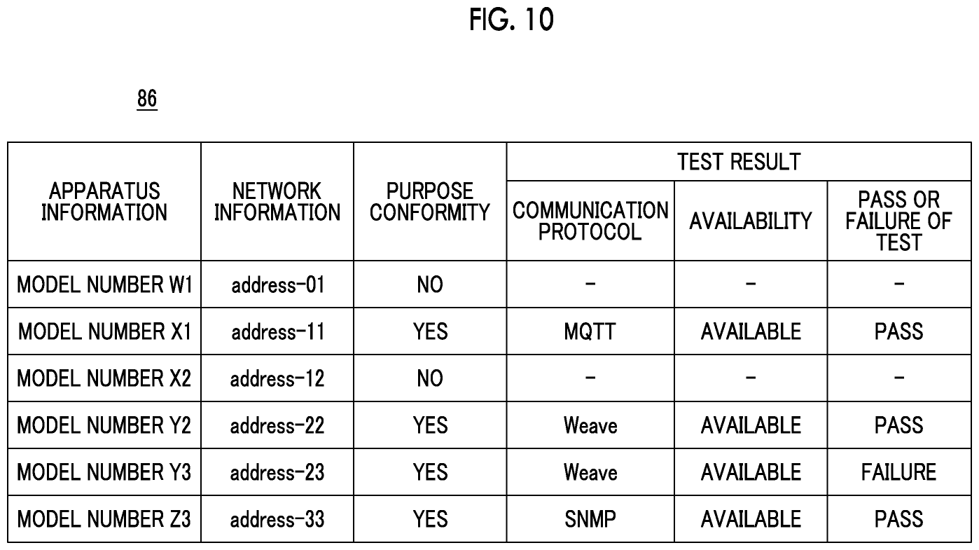

In step S14, the information comparison part 72 of the apparatus management part 70 checks whether or not the non-registered apparatus 20 is not yet listed on the apparatus candidate list 86 (FIG. 10) by comparing the IP address obtained in step S13. In a case where the non-registered apparatus 20 is already listed (YES in step S14), the operation of the present flowchart is ended. Ina case where the non-registered apparatus 20 is not yet listed (NO in step S14), a transition is made to subsequent step S15.

In step S15, the information comparison part 72 determines whether or not the non-registered apparatus 20 may generate data conforming with the collection purpose set in step S1 in FIG. 6. For example, the information comparison part 72 may perform the determination by sequentially comparing the apparatus information obtained in step S13 with the protocol information 84 and the logic information 82. For example, an establishment condition of the determination is exemplified by [Condition 1] the “apparatus information” and the “apparatus type” matching or similar to the apparatus information of the non-registered apparatus 20 are present in the protocol information 84 and [Condition 2] the analysis logic L in which the value of the “permission flag” corresponding to the “apparatus type” is “ON” is present in the logic information 82.

In a case where the non-registered apparatus 20 is the IoT apparatus 18 not satisfying the condition (NO in step S15), subsequent step S16 is omitted, and a transition is made to step S17. In a case where the non-registered apparatus 20 is the IoT apparatus 18 satisfying the condition (YES in step S15), a transition is made to step S16.

In step S16, the test execution part 74 of the apparatus management part 70 performs a registration process of trying to register the non-registered apparatus 20 as the data collection target. This registration process will be described in detail below.

In step S17, the list update part 76 of the apparatus management part 70 updates the apparatus candidate list 86 indicating a list of data collection target candidates by adding various information related to the non-registered apparatus 20. The operation of the image processing apparatus 14 related to the “automatic registration of the non-registered apparatus 20” is ended.

### Details of Collection Test

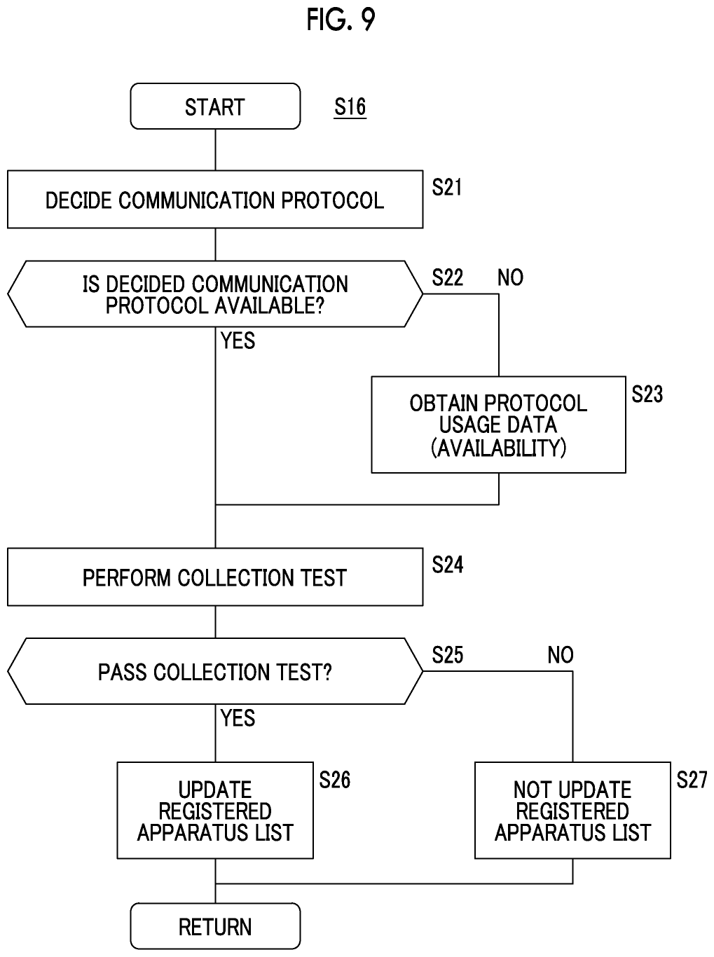

Next, an operation of executing a collection test in step S16 (FIG. 8) will be described in detail with reference to the flowchart in FIG. 9. The “collection test” means a test of checking whether or not the image processing apparatus 14 may collect data from the non-registered apparatus 20. Even in a state where the image processing apparatus 14 may communicate with the non-registered apparatus 20, data necessary for the collection purpose may not be obtained from the non-registered apparatus 20. The communication needs to be performed using an appropriate communication protocol in order for the image processing apparatus 14 to obtain data from the non-registered apparatus 20 with a data format and a data obtaining timing appropriate for the collection purpose.

### Flowchart

In step S21 in FIG. 9, the test execution part 74 of the apparatus management part 70 decides the communication protocol to be used in the collection test depending on the type of non-registered apparatus 20. Specifically, the test execution part 74 decides one or plural communication protocols corresponding to the type of non-registered apparatus 20 by reading and referring to the protocol information 84.

In step S22, the test execution part 74 checks whether or not the communication protocol decided in step S21 is available. In a case where the communication protocol is available (YES in step S22), subsequent step S23 is omitted, and a transition is made to step S24. In a case where the communication protocol is not available (NO in step S22), a transition is made to step S23.

In step S23, the test execution part 74 obtains obtaining location information included in the protocol information 84. Then, the test execution part 74 accesses the obtaining location indicated by the information and obtains data of a communication protocol module group (hereinafter, referred to as protocol usage data) for implementing communication for using the communication protocol. The “obtaining location information” is location information that enables specifying of the location of the protocol usage data. For example, the obtaining location information may be a uniform resource locator (URL) indicating a storage location in a server storing the protocol usage data.

In step S24, the test execution part 74 performs the data collection test with the non-registered apparatus 20 in accordance with the communication protocol decided in step S21. The collection test may be a simple response check test or may use a communication test mode in a case where the communication test mode is set in the non-registered apparatus 20. Specifically, the test execution part 74 may collect test data or actual data of the non-registered apparatus 20 and check whether or not the data is in a desired data format.

In step S25, the list update part 76 of the apparatus management part 70 checks whether or not the non-registered apparatus 20 passes the collection test performed instep S24. In the case of “pass” (YES in step S25), a transition is made to step S26. In the case of “failure” (NO in step S25), a transition is made to step S27.

In step S26, the list update part 76 updates the registered apparatus list 80 by adding various information related to the non-registered apparatus 20 passing the collection test. That is, the non-registered apparatus 20 is newly registered as the data collection target.

In step S27, the list update part 76 does not update the registered apparatus list 80 by not adding the non-registered apparatus 20 not passing the collection test. That is, the registration state of the non-registered apparatus 20 is maintained as “not registered”.

The registration process of the apparatus management part 70 is ended (step S16). Returning to the flowchart in FIG. 8, the list update part 76 updates the apparatus candidate list 86 by adding various information related to the non-registered apparatus 20 regardless of the result of the collection test executed in step S16.

FIG. 10 is a diagram illustrating one example of a data structure of the apparatus candidate list 86. The apparatus candidate list 86 is table data indicating a correspondence relationship among the apparatus information, the network information, purpose conformity, and the test result. The “purpose conformity” indicates the determination result of step S15 (FIG. 8). The test result is maintained only in the case of “YES”. The “test result” includes [1] the used communication protocol, [2] whether or not the communication protocol is available, and [3] whether or not the non-registered apparatus 20 passes the test.

### Conclusion

As described thus far, the image processing apparatus 14 as the data processing apparatus includes the purpose setting part 64 (setting section) that sets information related to the purpose of collecting data from the apparatus group 16 consisting of plural IoT apparatuses 18 (apparatuses), the apparatus recognition part 68 (recognition section) that recognizes the non-registered apparatus 20 which may perform bidirectional communication and is not yet registered as the data collection target, and the apparatus management part 70 (apparatus management section) that registers the non-registered apparatus 20 as the data collection target in a case where data conforming with the set purpose may be collected from the recognized non-registered apparatus 20.

in addition, according to the data processing method and the program, one or plural computers execute a setting step (S1 in FIG. 6) of setting information related to the purpose of collecting data from the apparatus group 16 consisting of plural IoT apparatuses 18, a recognition step (S11 in FIG. 8) of recognizing the non-registered apparatus 20 which may perform bidirectional communication and is not yet registered as the data collection target, and an apparatus management step (S26 in FIG. 9) of registering the non-registered apparatus 20 as the data collection target in a case where data conforming with the set purpose may be collected from the recognized non-registered apparatus 20.

In addition, the apparatus management part 70 checks whether or not data may be collected from the non-registered apparatus 20 and registers only the non-registered apparatus 20 from which data may be collected. In addition, the apparatus management part 70 may decide the communication protocol related to the collection of data depending on the type of non-registered apparatus 20 and collect data in accordance with the decided communication protocol. In addition, the apparatus management part 70 may decide the communication protocol corresponding to the non-registered apparatus 20 using the protocol information 84 indicating a correspondence relationship between the type of IoT apparatus 18 and the type of communication protocol. In addition, in a case where the communication protocol to be used in the collection of data is not available, the apparatus management part 70 may obtain the protocol usage data from the obtaining location indicated by the obtaining location information included in the protocol information 84. In addition, the storage device 42 (storage section) stores the registered apparatus list 80. The apparatus management part 70 may register the non-registered apparatus 20 as the data collection target by adding the communication protocol used in the collection of data to the registered apparatus list 80 in association with the apparatus information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data processing apparatus comprising:
a setting section that sets information related to a purpose of collecting data from an apparatus group consisting of a plurality of apparatuses;
a recognition section that recognizes a non-registered apparatus which performs bidirectional communication and is not yet registered as a data collection target; and
an apparatus management section that registers the non-registered apparatus in a case where data conforming with the purpose set by the setting section is collected from the non-registered apparatus recognized by the recognition section.

2. The data processing apparatus according to claim 1,
wherein the apparatus management section checks whether or not the data is collected from the non-registered apparatus and registers only the non-registered apparatus from which the data is collected.

3. The data processing apparatus according to claim 2,
wherein the apparatus management section decides a communication protocol related to the collection of the data depending on a type of the non-registered apparatus and collects the data in accordance with the decided communication protocol.

4. The data processing apparatus according to claim 3, further comprising:
a storage section that stores protocol information indicating a correspondence relationship between the type of non-registered apparatus and a type of the communication protocol,
wherein the apparatus management section decides the communication protocol corresponding to the non-registered apparatus using the protocol information stored in the storage section.

5. The data processing apparatus according to claim 4,
wherein the protocol information further includes obtaining location information indicating an obtaining location of protocol usage data for using the communication protocol, and
in a case where the communication protocol to be used in the collection of the data is not available, the apparatus management section obtains the protocol usage data from the obtaining location indicated by the obtaining location information.

6. The data processing apparatus according to claim 3, further comprising:
a storage section that stores a registered apparatus list including apparatus information for identifying or classifying the non-registered apparatus registered by the apparatus management section,
wherein the apparatus management section registers the non-registered apparatus as the data collection target by adding the communication protocol used in the collection of the data to the registered apparatus list in association with the apparatus information.

7. The data processing apparatus according to claim 1,
wherein the setting section sets an analysis logic that outputs an analysis result corresponding to the purpose from collected data.

8. The data processing apparatus according to claim 7, further comprising:
an analysis section that performs an analysis process on the data in accordance with one or a plurality of the analysis logics set by the setting section.

9. A data processing method executed by one or a plurality of computers, comprising:
setting information related to a purpose of collecting data from an apparatus group consisting of a plurality of apparatuses;
recognizing a non-registered apparatus which performs bidirectional communication and is not yet registered as a data collection target; and
registering the non-registered apparatus in a case where data conforming with the set purpose is collected from the recognized non-registered apparatus.

10. A non-transitory computer readable medium storing a data processing program causing one or a plurality of computers to execute:
setting information related to a purpose of collecting data from an apparatus group consisting of a plurality of apparatuses;
recognizing a non-registered apparatus which performs bidirectional communication and is not yet registered as a data collection target; and
registering the non-registered apparatus in a case where data conforming with the set purpose is collected from the recognized non-registered apparatus.
